(19) United States
(12) Patent Application Publication
(10) Pub. No.: US 2018/0113979 A1
(43) Pub. Date: Apr. 26, 2018

(54) SAFE PARALLELIZED INGESTION OF DATA UPDATE MESSAGES, SUCH AS HL7 MESSAGES

(71) Applicant: CARADIGM USA LLC, Bellevue, WA (US)

(72) Inventors: Enez A. McCondochie, Redmond, WA (US); Henner C. Dierks, Snoqualmie, WA (US); Benjamin L. Chronister, Woodinville, WA (US); Bala Triveni Seelamsetty, Issaquah, WA (US); Jayakarthik Sabapathy, Bellevue, WA (US); Liqun Fu, Mercer Island, WA (US); Tiberiu M. Doman, Kirkland, WA (US); Friederike D. Waupotitsch, San Ramon, CA (US)

(21) Appl. No.: 15/384,122

(22) Filed: Dec. 19, 2016

Related U.S. Application Data
(60) Provisional application No. 62/412,166, filed on Oct. 24, 2016.
(60) Provisional application No. 62/421,145, filed on Nov. 11, 2016.

(51) Int. Cl. G06F 19/00; H04L 12/58

(52) U.S. Cl. CPC G06F 19/321; H04L 51/16

(57) ABSTRACT

A facility for processing data update messages is described. The facility establishes a plurality of units of execution each for executing data update message processing code. The facility receives data update messages from a plurality of sending devices, and assigns each received data update message to a unit of execution without regard for which sending device it was received from. In each unit of execution, the facility executes the code to process the received data update messages to which it is assigned.

### CROSS-REFERENCE TO RELATED APPLICATION(S)

The present application claims the benefit of U.S. Provisional Patent Application No. 62/412,166, filed on Oct. 24, 2016, and U.S. Provisional Patent Application No. 62/421,145, filed on Nov. 11, 2016, which are each hereby incorporated by reference in their entireties. In cases where an application incorporated by reference and the present application conflict, the present application controls.

### BACKGROUND

HL7 (Health Level Seven) is an ANSI standard for the exchange, integration, sharing and retrieval of electronic health information between disparate systems. Each HL7 message defines the purpose for the message being sent, for example, a “patient admit,” “patient discharge,” “update patient information” or “patient merge” message. Clients such as healthcare providers will typically transmit different types of HL7 messages to be ingested by a data store.

A data store that ingests HL7 messages in an order other than they were sent by clients is at risk of falling out of synchronization with the clients, and/or containing incorrect or out-of-date data. Accordingly, conventional data stores perform ingestion of HL7 messages in a serial fashion, establishing a separate, stand-alone process for each combination of a client and a message type that is dedicated to ingesting the HL7 messages of that type from that client in the order that that client created them.

### BRIEF DESCRIPTION OF THE DRAWINGS

FIG. 1 shows a network environment in which the facility operates in some embodiments.

FIG. 2 is a block diagram showing some of the components typically incorporated in at least some of the computer systems and other devices on which the facility operates.

FIG. 3 is a component diagram illustrating programmatic and data storage components used by the facility in some embodiments, and selected interactions between them.

FIG. 4 is a pipeline diagram illustrating the processing pipeline operated by the facility in some embodiments.

FIG. 5 is a flow diagram showing a process performed by the facility in some embodiments to collect messages generated at a tenant location.

FIG. 6 is a flow diagram showing a process typically performed by the facility at each tenant location to transmit batches of messages of a certain type.

FIG. 7 is a flow diagram showing a process performed by the facility in the data center in some embodiments to receive message batches from tenant locations.

FIG. 8 is a table diagram showing an example of the facility's assignment of sequence numbers to messages received in the data center.

FIG. 9 is a flow diagram showing a process performed by the facility in some embodiments in the data center to process received messages.

FIG. 10 is a flow diagram showing a process performed by the facility in some embodiments in the data center to populate the entity data model as part of act 907.

FIG. 11 is a hierarchy diagram showing the correlation type hierarchy.

FIG. 12 is a hierarchy diagram showing an example of moving references within a correlation hierarchy in accordance with Scenario 2(b).

### DETAILED DESCRIPTION

The inventors have recognized that conventional approaches to the ingestion of HL7 messages have significant disadvantages. For example, where ingestion is being performed on behalf of a large number of clients, the computing resources needed to maintain a separate process for serialized ingestion of each type of each client's messages is very large. Also, in order to maintain the integrity of the data store contents across hardware outages, rigorous, specialized fail-over mechanisms must be employed. The approach is also poorly-suited for parallel processing, multi-tenant environments, such as cloud computing environments.

In response to recognizing the foregoing disadvantages, the inventors have conceived and reduced to practice a software and/or hardware facility for safe parallelized ingestion of data update messages, such as HL7 messages (“the facility”).

The facility uses a load-balanced software process within a multi-tenant environment to simultaneously process different types of messages from different source systems. In some embodiments, the facility performs this processing using parallel processing techniques, in which the same or equivalent programs are executed simultaneously by multiple units of execution, such as separate machines, processors, cores, virtual machines, processes, threads, and/or other such resources. In some embodiments, the facility applies different processing rules for each tenant and ensures that the processed tenant data is stored within the tenant specific operational data store. This stored data can be accessed directly by the tenant, and/or programmatically accessed and analyzed by analytical applications on the tenant's behalf.

An HL7 “update” message contains a trigger event requiring that the receiving application extract additional patient demographic data elements and include them in the existing patient's record. The facility extracts and updates the demographic data for existing patient records without loss and/or misinterpretation of data despite the use of more efficient load-balancing techniques.

A typical hospital organization has multiple locations. Each location may have its own systems for Admissions, Medications, Labs, etc. When a patient visits a location, a visit number is generated. Multiple visits for the same patient may be grouped into a billing entity, usually an “Account”. Each location maintains a “folder” per patient. This folder contains all the accounts for the patient and assigns a unique number called “Medical Record Number” (MRN). The healthcare organization as a whole may maintain a single identifier for the person across all locations. This identifier is usually called the “Enterprise Master Patient Identifier” (EMPI). Treatment for the patient may precede the admissions process, such as in the case of a patient having a cardiac arrest or a patient involved in an accident. As a result, patient identification may not be accurate. Multiple identifiers may be created for the same visit by different systems within the same location. All of these issues result in persons, patients, accounts and visits being merged or moved. Patient safety is often dependent on correct data being surfaced to physicians, and this in turn depends on correct identification of the patient. Accordingly, In some embodiments, the facility accommodates a fluid patient identification process. An HL7 “merge person” message or “unmerge person” message contains a trigger event that requires the receiving application to merge/unmerge the records for a patient that was incorrectly filed under two different internal IDs. The facility merges/unmerges records for an existing patient across different institutions without loss and/or misinterpretation of data despite the use of load-balanced and probable out of order message processing techniques.

HL7 distinguishes between two modes of update. Both modes apply to repeating segments and repeating segment groups:
Snapshot processing mode for repeating fields involves sending a full list of repetitions for each transaction. If the intent is to delete an element, the element is omitted from the list. In snapshot processing mode, the content of the incoming/received HL7 message is used to replace the contents from a previously processed and stored message for the same information object. The facility ensures HL7 snapshot mode messages are processed without loss or misinterpretation.
In “action code/unique identifier” mode, each member of a repeating group of segments has a unique identifier which identifies one of multiple repetitions of the primary entity defined by the repeating segment in a way that does not change over time. The choice of delete/update/insert is determined by an action code included in the message. The facility ensures HL7 action code/unique identifier mode messages are processed without loss or misinterpretation.

Each HL7 field can have one of three states: (a) populated, (b) not populated/blank/empty, or (c) null. In some embodiments, the facility applies incremental updates based on the three states without loss and/or misinterpretation:
If a field is populated, the contents of the field will be the content of the data element going forward.
In HL7, a null value for a field is indicated by paired double quotes inside field limiters (|″″|). The null value applies to the field as a whole, not to the components/subcomponents of the field. A null field value indicates that the receiver of the message should delete the corresponding set of information from the data store.
If a field is not populated, it is important to determine the previous content from the previously received messages for the same dataset and use this previous content going forward. If a field is not contained at the end of a higher level field, then it is assumed to be implicitly existent and not populated.

A load-balanced environment is one where there are a cluster of computers all with the same software process(es) running on them so that the work can be shared by multiple computers and more work can get done within the same amount of time. Processing data in parallel means that data can be received and processed out-of-order.

The facility performs out-of-order processing of HL7 message data in a load-balanced environment by assigning and operating in accordance with message sequence numbers to enable the correct sequence of processing. Sequence numbers are unique across all tenants and their incoming tenant feeds, and message types. The facility generates sequence numbers based on a tenant-specific synchronized resource to guarantee uniqueness. In some embodiments, each tenant has its own data store which maintains the last issued sequence number. When a HL7 message or a batch of HL7 messages is received, the facility assigns the next sequence number ensuring the correct order of messages is maintained.

Once the sequence number is assigned, the facility extracts the required patient demographic data elements and includes them in the existing patient record in the correct order.

Another significant problem that the facility solves is the problem of how to process merge and move messages out of sequence. When a HL7 “merge person” message or “unmerge person” message is received, the facility merges/unmerges the records for a patient that were incorrectly filed under the wrong identifier(s).

By performing some or all of the ways described above, the facility allows the ingestion of data update messages, such as HL7 messages, to be performed efficiently and securely.

### HL7 Message:

HL7 Messages are used to transfer electronic data between disparate healthcare systems. Each HL7 message sends information about a particular event such as a patient admission. The parser processes HL7 data. Each HL7 message consists of one or more segments. A “carriage return” character separates one segment from another. Each segment is displayed on a different line of text as seen in the sample HL7 message below. Each segment, when configured, represents a table with the data ingestion pipeline data store:

TABLE 1
Sample Message 1

MSH|\hat{ }~\&|GAUL_APP|GAULISH MEDICAL CENTER|||201501010000||ORU\hat{ }R01|||2.5|
PID|0001|EMPI-001|MRN-001||||||||||||||||ACCOUNT-001||
PV1|0001|I|||||||||||||||||VISIT-001||||||||||||||||||||||||||

### Collapsed Data:

This term refers to data that is updated when it already exists and inserted when it does not. It is the antithesis of an insert-only data storage strategy.

As an example, the two messages shown below in Tables 2 and 3 are being processed at a time when the collapse key has been configured as the value of the data element PID_3 (000001971):

TABLE 2
Sample Message 2

MSH|\hat{ }~\&|MSC|NEW_MSH|||201201051328||ADT\hat{ }A04|TR-ADTOE24.1.18952|D|2.4|||AL|NE
PID|1|000000000081664|000001971|000001971|HIE\hat{ }PATIENT2\hat{ }\hat{ }\hat{ }\hat{ }\hat{ }L||19540205|M||2028-
9|0000 S 18TH STREET\hat{ }\hat{ }SOMECITY\hat{ }IL\hat{ }60608\hat{ }\hat{ }\hat{ }\hat{ }COO||111-111-0000\hat{ }PRN|222-222-
1111\hat{ }WPN||D|VAR|000000025544

TABLE 3
Sample Message 3

MSH|\hat{ }~\&|MSC|NEW_MSH|||201201051328||ADT\hat{ }A04|TR-ADTOE24.1.18952|D|2.4|||AL|NE
PID|1|000000000081664|000001971|000001971|HIE\hat{ }PATIENT2\hat{ }\hat{ }\hat{ }\hat{ }\hat{ }L||19540205|M||2028-
9|2^{nd} NE STREET\hat{ }\hat{ }CHICAGO\hat{ }IL\hat{ }60608\hat{ }\hat{ }\hat{ }\hat{ }COO||111-111-0000\hat{ }PRN\hat{ }222-222-
1111\hat{ }WPN||D|VAR|000000025544

The resulting PID table, shown below in Table 4, has only one row, with an updated address:

### Collapse Key:

A collapse key uniquely identifies a row of data. The sample message shown below in Table 5, contains the following segments: MSH (message header), PID (patient identification), and PV1 (patient visit information).

TABLE 5
Sample Message 4

MSH|\hat{ }~\&|GAUL_APP|GAULISH MEDICAL CENTER|||201501010000||ORU\hat{ }R01|||2.5|
PID|0001|EMPI-001|MRN-001||||||||||||||||ACCOUNT-001||
PV1|0001|1|||||||||||||||||VISIT-001||||||||||||||||||||||||||

The process of configuring a collapse key involves identifying which field or combination of fields will uniquely identify the HL7 segment data. It also configures which “collapsed” data will be stored within the system. If the collapse key is not configured for a segment, then that segment's data will not be stored within the system as a separate “table” of “collapsed” data. While the facility in some embodiments always stores the raw message, it only collapses data that has been configured as a collapsed key. The same segment can be used to configure multiple collapse keys—this results in different “collapsed views” of the data.

### HL7 Message Construction Rules (for Incremental HL7)

| | |
|---|---|
| Field Separator | \| |
| Component Separator | \hat{ } |
| Subcomponent Separator | & |
| Repetition Separator | ~ |

1. The first three characters of a segment are its segment ID code.
2. Immediately after the segment ID code, a field separator is placed in the segment.
3. If the value of the field is not present, no further characters are required
4. If the value of the field is present, but null, the characters ‘″″’ are placed in the field.
5. Otherwise, the characters of the value are placed in the segment immediately after the field separator. As many characters can be included as the maximum defined for the data field. It is not necessary, and is undesirable, to pad fields to fixed lengths. Padding to fixed lengths is permitted, however.
6. If the field definition calls for a field to be broken into components, the following rules are used:
   I. If more than one component is included they are separated by the component separator.
   II. Components that are present but null are represented by the characters ″″.
   III. Components that are not present are treated by including no characters in the component.
   IV. Components that are not present at the end of a field need not be represented by component separators. For example, the two data fields are equivalent: |ABC∧DEF∧∧| and |ABC∧DEF|.
7. If the component definition calls for a component to be broken into subcomponents, the following rules are used:
   I. If more than one subcomponent is included they are separated by the subcomponent separator.
   II. Subcomponents that are present but null are represented by the characters ″″.
   III. Subcomponents that are not present are treated by including no characters in the subcomponent.
IV. Subcomponents that are not present at the end of a component need not be represented by subcomponent separators. For example, the two data components are equivalent: ∧XXX&YYY&&∧ and ∧XXX&YYY∧.
8. If the field definition permits repetition of a field, the following rules are used; the repetition separator is used only if more than one occurrence is transmitted and is placed between occurrences. (If three occurrences are transmitted, two repetition separators are used.) In the example below, two occurrences of telephone number are being sent: |234-7120˜599-1288B1234|

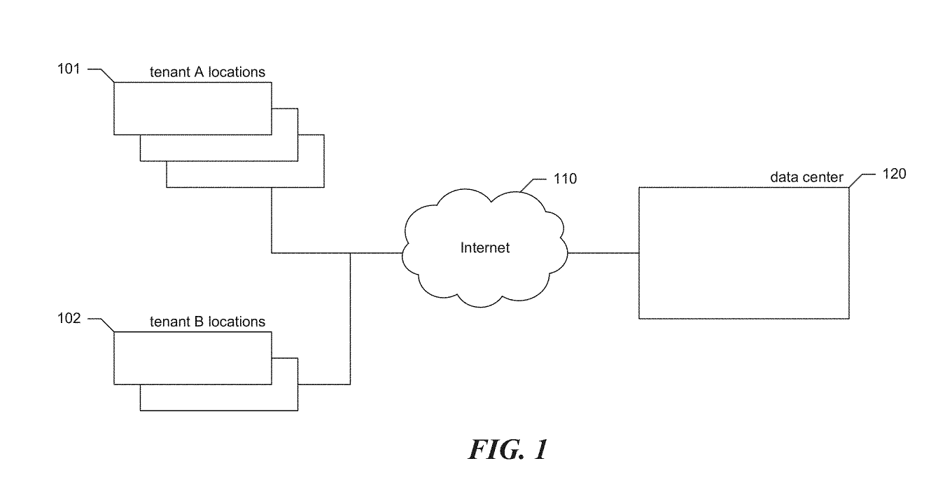

FIG. 1 shows a network environment in which the facility operates in some embodiments. In this environment, computer systems and other devices at multiple locations of multiple tenants, such as tenant A locations 101 and tenant B locations 102, generate and batch data update messages. These are sent via the internet 110 or another network to a data center 120, such as the data center hosting a cloud computing service. In the data center, the facility applies the update messages to data stores maintained for each tenant.

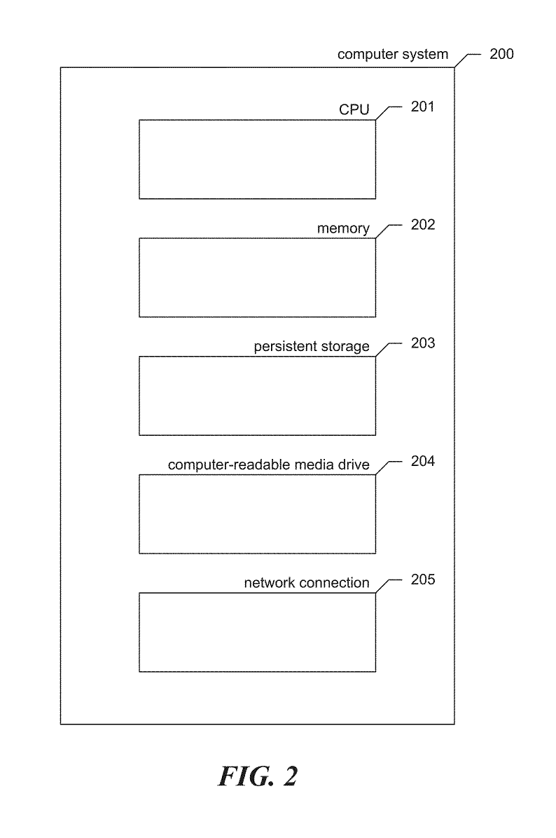

FIG. 2 is a block diagram showing some of the components typically incorporated in at least some of the computer systems and other devices on which the facility operates. In various embodiments, these computer systems and other devices 200 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 201 for executing computer programs; a computer memory 202 for storing programs and data while they are being used, including the facility and associated data, an operating system including a kernel, and device drivers; a persistent storage device 203, such as a hard drive or flash drive for persistently storing programs and data; a computer-readable media drive 204, such as a floppy, CD-ROM, or DVD drive, for reading programs and data stored on a computer-readable medium; and a network connection 205 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. In some embodiments, one or more virtualization layers is interposed between the hardware components of the computer system and the facility and/or other software. While computer systems configured as described above are typically used to support the operation of the facility, those skilled in the art will appreciate that the facility may be implemented using devices of various types and configurations, and having various components.

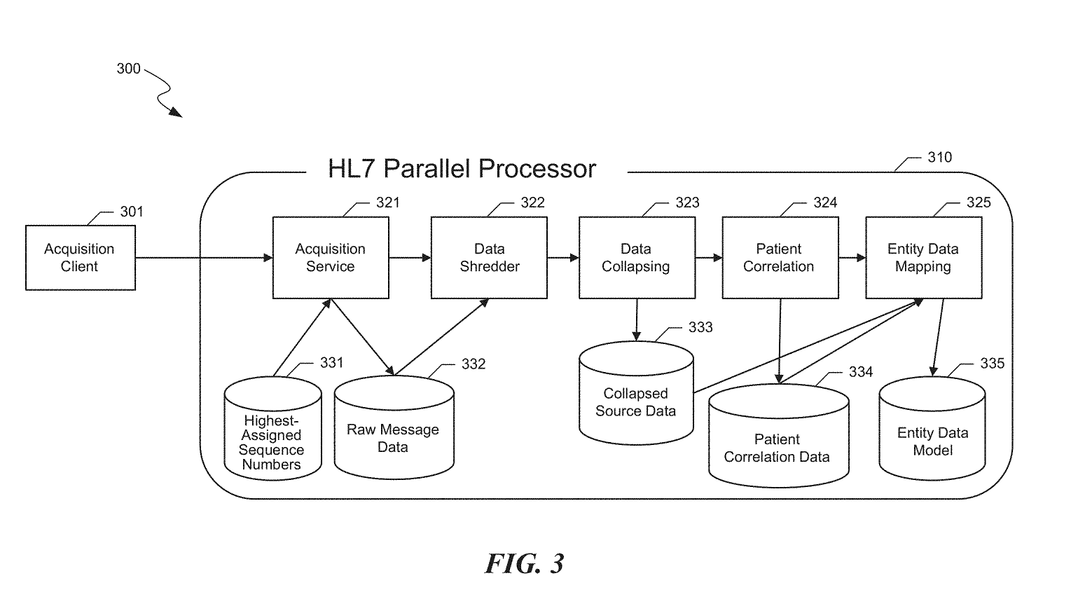

FIG. 3 is a component diagram illustrating programmatic and data storage components used by the facility in some embodiments, and selected interactions between them. The components generally 300 include acquisition clients 301, and programmatic and data storage components 310 used to ingest messages provided in batches by the acquisition clients. An acquisition service 321 receives message batches from the acquisition clients. The acquisition service accesses stored highest-assigned sequence number 331. In particular, it atomically updates the highest-assigned sequence number to increase it by the number of messages in the batch, and assigns the range of sequence numbers immediately above the former highest-assigned sequence number to the messages of the batch in order. It attaches the assigned sequence numbers to versions of the messages that are stored as raw message data 332, and passes the sequence numbers to a data shredder 322. The data shredder “shreds” data in each raw message into tables and table columns. A data collapser 323 extracts data corresponding to collapsed keys, applying a transformation if needed to, for example, concatenate fields. It stores this collapsed data 333. A patient correlator 324 extracts correlation identifiers, updates patient correlation data 334, and manages correlation re-parent and merge operations. An entity data mapper 325 populates the entity data model 335, applying transformations if needed, such as to concatenate fields or formatting dates and times, accessing the collapsed source data and patient correlation data. It should be noted that, in some embodiments, each of programmatic services 321-325 is simultaneously performed in several interchangeable processes or threads, each of which can process messages and the information derived from the them that are from any tenant, tenant location, or message feed.

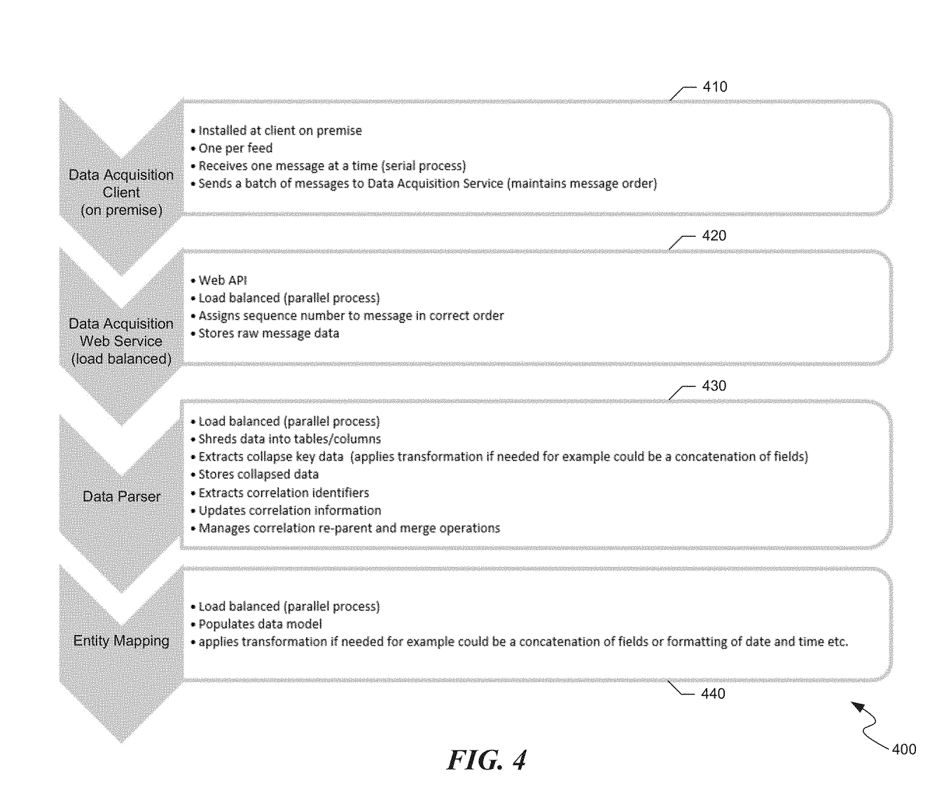

FIG. 4 is a pipeline diagram illustrating the processing pipeline operated by the facility in some embodiments. A data acquisition client 410 is installed on each client device at each provider of medical services. One instance of the data acquisition client is executed for each feed of medical information. The data acquisition client receives one message at a time from client software, and sends a batch of messages to a data acquisition service in which the received message order is maintained. A web acquisition web service 420 has a web API for receiving the message batches from the data acquisition clients. It is implemented in a load-balanced, parallel-processing manner. The data acquisition web service assigns a sequence number to each message, and stores raw message data. A data parser 430 is also implemented in a load-balanced, parallel-processing manner. It “shreds” data into tables and table columns. It extracts data corresponding to collapsed keys, applying a transformation if needed to, for example, concatenate fields. It stores this collapsed data, extracts correlation identifiers, updates correlation information, and manages correlation re-parent and merge operations. An entity mapping stage is also implemented in a load-balanced, parallel-processing manner. It populates the data model, applying transformations if needed, such as to concatenate fields or formatting dates and times.

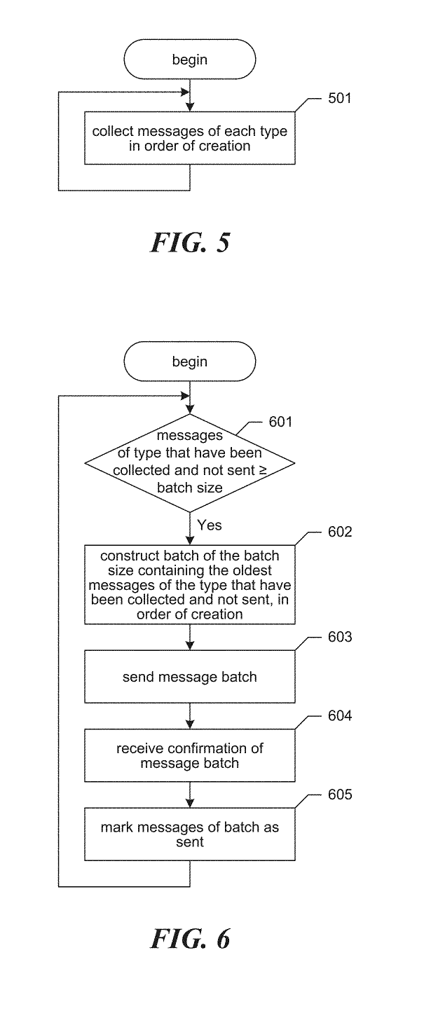

FIG. 5 is a flow diagram showing a process performed by the facility in some embodiments to collect messages generated at a tenant location. In act 501, for each different type of message, the facility collects messages of this type in order of their creation at the tenant location. The facility performs act 501 continuously.

FIG. 6 is a flow diagram showing a process typically performed by the facility at each tenant location to transmit batches of messages of a certain type. In each tenant location, the facility typically performs this process separately for each different message type. In act 601, the facility waits for the number of messages of the selected type that have been collected and not yet sent to reach a batch size, such as a batch size of 5 messages, 50 messages, 500 messages. In some embodiments (not shown), the facility proceeds to act 602 after a period of predetermined length has passed, such as a minute, an hour, or a day, irrespective of the number of collected messages. At this point, in act 602, the facility constructs a batch of messages that is of the batch size and that contains the oldest messages of the selected type that have been collected in act 501 but not yet sent, in the order of creation of these messages. In act 603, the facility sends the message batch to the data center. In act 604, the facility receives from the data center confirmation that the message batch has been received at the data center and assigned sequence numbers. In act 605, the facility marks the messages of the batch constructed in step 602 as sent. After act 605, the facility continues in act 601 to process the next batch of messages.

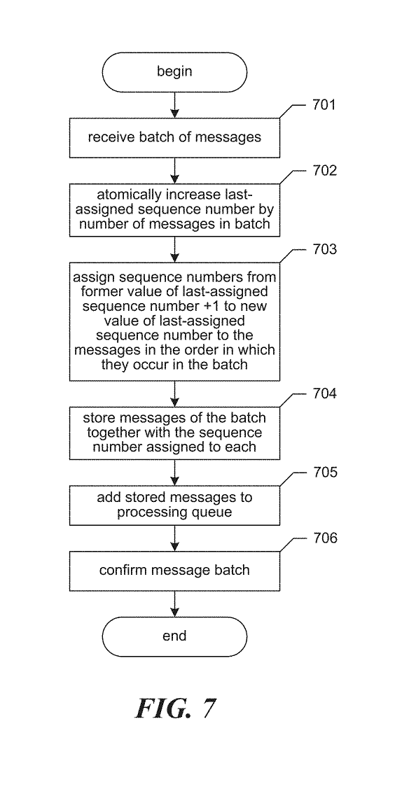

FIG. 7 is a flow diagram showing a process performed by the facility in the data center in some embodiments to receive message batches from tenant locations. In some embodiments, the facility performs this process simultaneously in several processes or threads to receive message batches of any message type from any tenant location. In act 701, the facility receives a batch of messages sent from a client location in act 603. In act 702, the facility atomically increases a single last-assigned sequence number maintained by the facility in the data center by the number of messages that are in the batch received in act 701. In act 703, the facility uses the former and increased last-assigned sequence numbers to assign sequence number to the messages of the batch as follows: the first message of the batch receives as its sequence number the former value of the last-assigned sequence number plus 1; the second message of the batch receives as its sequence number the former value of the last-assigned sequence number plus 2; etc. In this way, the sequence numbers assigned to the messages by the facility reflect the order of the messages in the batch, and ultimately reflect the order of creation of the messages in the batch. In act 704, the facility stores the messages of the batch together with the sequence numbers assigned to them in act 703. In act 705, the facility adds the messages stored in act 704 to a processing queue, such as by adding to the processing queue the sequence numbers assigned to the stored messages, or other kinds of identifiers of or pointers to the stored messages. In act 706, the facility sends a confirmation of the message batch from the data center to the tenant location, permitting the tenant location to send the next batch of messages of the same type. After act 706, this process concludes.

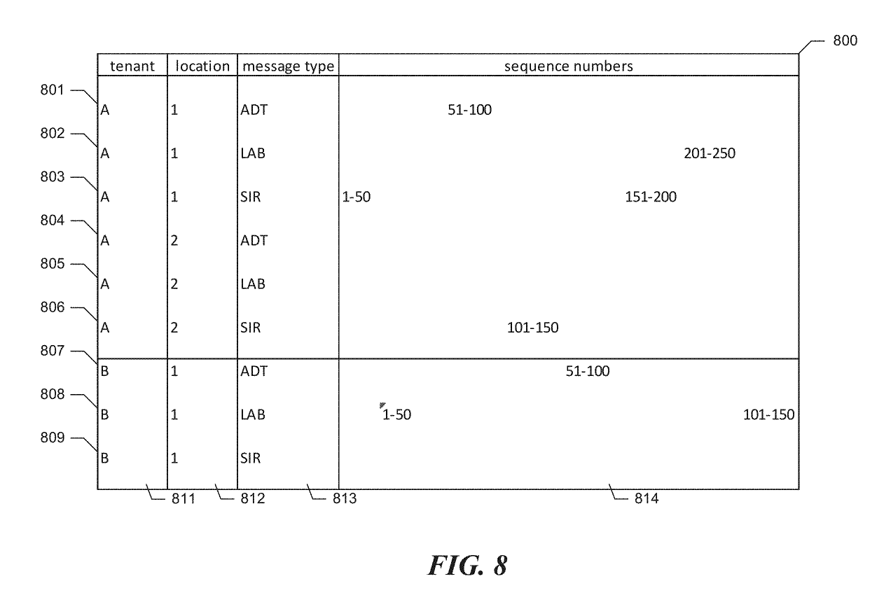

FIG. 8 is a table diagram showing an example of the facility's assignment of sequence numbers to messages received in the data center. In the table, each row corresponds to a different combination of tenant identity 811, tenant location 812, and message type 813, and shows the sequence numbers assigned to batches of messages received for these combinations of tenant, location, and type. Recall that the data center receives batches of messages that each correspond to a particular tenant, tenant location, and message type. In the sequence numbers column 814, row 803 shows that a batch of 50 SIR messages from tenant A in location 1 is the first batch to be processed for tenant A, at a time when the last-assigned sequence number for tenant A is zero. Accordingly, the facility increases the last-assigned sequence number by 50 to 50, and assigns sequence numbers 1-50 to the messages of the batch. The next batch of messages to be processed is a batch of LAB messages from tenant B in location 1. This batch of messages is the first batch to be processed for tenant B, at a time when the last-assigned sequence number for tenant B is zero. Accordingly, the facility increases the last-assigned sequence number by 50 to 50, and assigns sequence numbers 1-50 to the messages of the batch. The facility increases the last-assigned sequence number from 0 to 50 for the subsequent batch of messages for tenant B. This process further continues to assign the other sequence numbers shown in column 814. It should be noted that, while the messages in the first batch of SIR messages from tenant A in location 1 was processed before the first batch of ADT messages from tenant A in location 2, it is not necessarily true that the first batch of SIR/A/1 messages was received before the first batch of ADT/A/2 messages, or that any of the SIR/A/1 messages was created before any of the ADT/A/2 messages. On the other hand, within a single combination of tenant, location, and message type (e.g., within a single row of this table), the assigned sequence numbers correctly reflect the order of creation of the messages of this type from this tenant and location. For example, the message having sequence number 1 is the first LAB message created by tenant B at location 1; the message having sequence number 2 is the second LAB message created by the tenant B at location 1, and so on through sequence number 50. Sequence number 151 is assigned to the 51st LAB message created by tenant B at location 1, and sequence number 150 is assigned to the 100th. Thus, the facility can and does treat the sequence numbers assigned to each message as correctly reflecting message creation order for a particular combination of message type, tenant, and location.

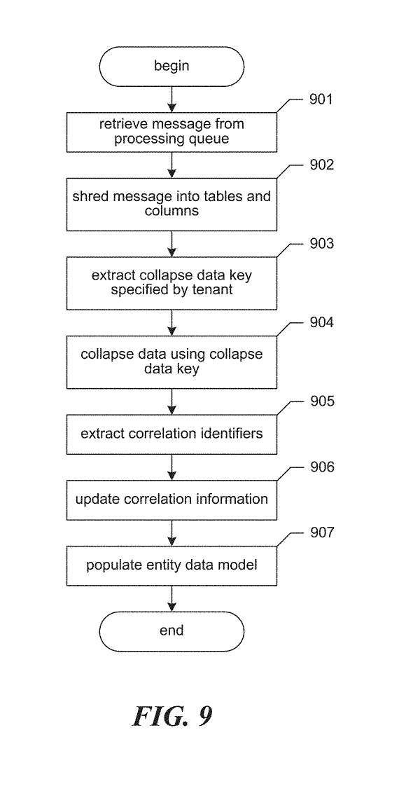

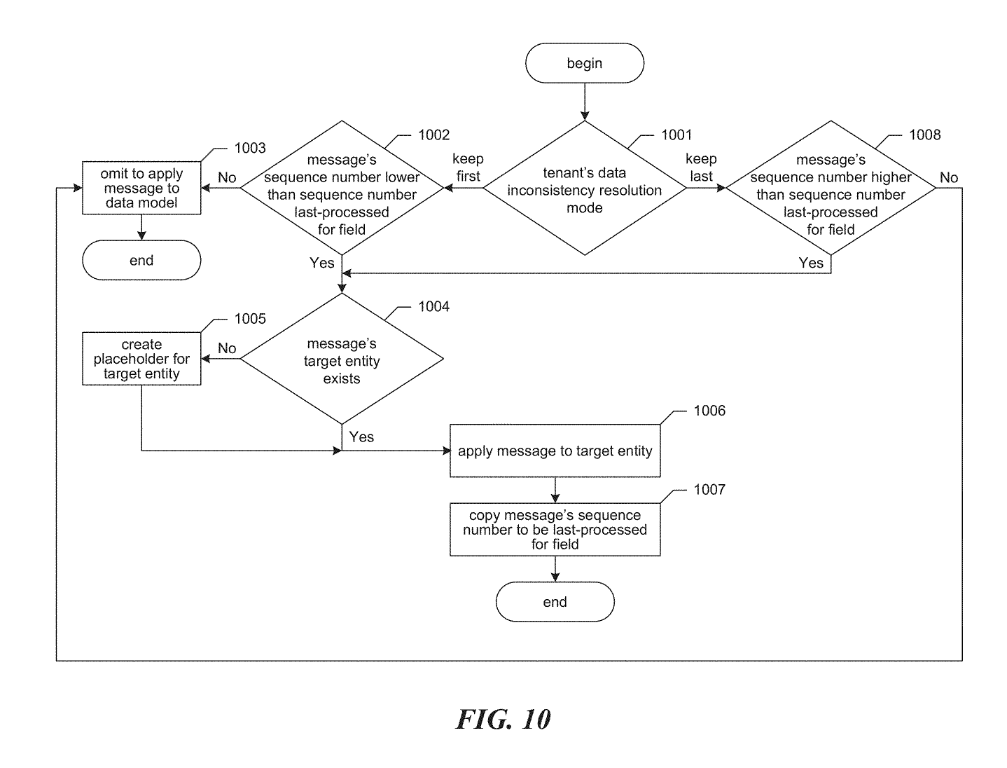

FIG. 9 is a flow diagram showing a process performed by the facility in some embodiments in the data center to process received messages. In some embodiments, this process is performed simultaneously by multiple processes or threads to collectively service the messages placed in the processing queue by the facility in act 705 shown in FIG. 7. In act 901, the facility retrieves a message from the processing queue. In act 902, the facility shreds the message into tables and columns. In act 903, the facility extracts from the shredded message the collapse data key that is specified by the client for its data. In act 904, the facility collapses the shredded message data using the collapse data key extracted in act 903. In act 905, the facility extracts correlation identifiers from the collapsed data. In act 906, the facility updates correlation information. In act 907, the facility uses the determined correlation in the collapsed data to populate the entity data model. Additional details about act 907 are shown in FIG. 10 and discussed below. After act 907, this process concludes.

FIG. 10 is a flow diagram showing a process performed by the facility in some embodiments in the data center to populate the entity data model as part of act 907. In act 1001, if the data inconsistency resolution mode specified by the tenant is the “keep first” data inconsistency resolution mode, then the facility continues in act 1002, else the facility continues in act 1008. In act 1002, if the message's sequence number is lower than the sequence number stored as having been last-processed for the field, then the facility continues in act 1004, else the facility continues in act 1003. In act 1003, the facility omits to apply the current message to the data model, as the current message's sequence number indicates that the message is superfluous in the light of the tenant's selection of data inconsistency resolution mode. After act 1003, this process concludes.

In act 1004, if the target entity determined for the message by the facility exists in the data model, then the facility continues in act 1006, else the facility continues in act 1005. In act 1005, the facility creates in the data model a placeholder for the target entity determined for the message. In act 1006, the facility applies the message to the target entity. In act 1007, the facility copies the sequence number of the message to be the new last-processed sequence number for the field. After 1007, this process concludes.

### Correlation:

A typical hospital organization has multiple locations. Each location may have its own systems for Admissions, Medications, labs, etc. When a patient visits a location, a visit number is generated. Multiple visits for the same patient may be grouped into a billing entity, usually an “Account”. Each location maintains a “folder” per patient. This folder contains all the accounts for the patient and assigns a unique number called “Medical Record Number” (MRN). The healthcare organization as a whole may maintain a single identifier for the person across all facilities. This identifier is usually called the “Enterprise Master Patient Identifier” (EMPI). Treatment for the patient may precede the admissions process for example: a patient having a cardiac arrest or a patient involved in an accident. As a result, patient identification may not be accurate. Multiple identifiers may be created for the same visit by different systems within the same facility. All of these issues result in persons, patients, accounts and visits being merged or moved. Patient safety is dependent on correct data being surfaced to physicians, and this in turn depends on correct identification of the patient. Storage of data must account for the fact that patient identification is a fluid process. An HL7 “merge person” message or “unmerge person” message contains a trigger event that requires the receiving application to merge/unmerge the records for a patient that was incorrectly filed under two different internal IDs. Correlation is the process of merging/unmerging records for an existing patient across different institutions.

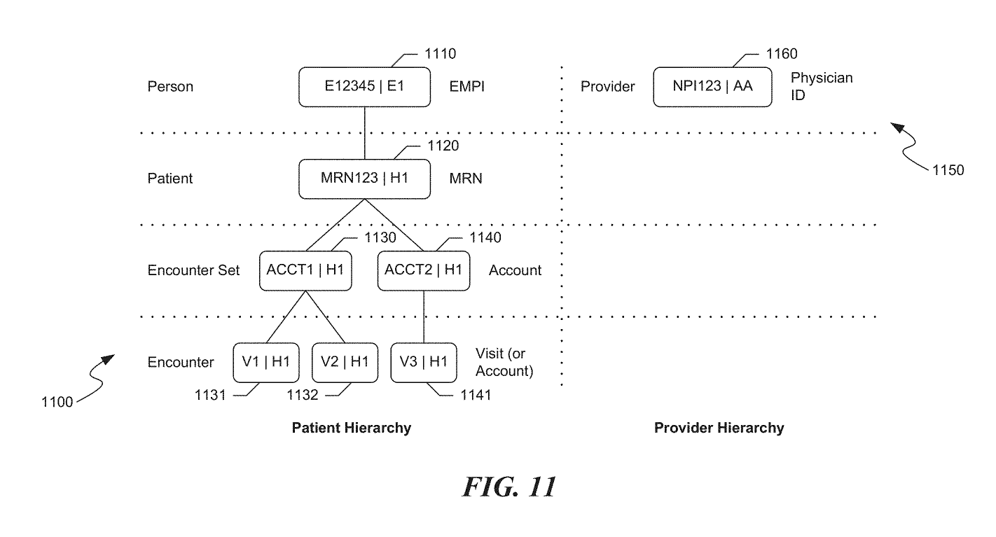

In some embodiments, the facility uses five correlation types:—Provider, Person, Patient, Encounter set and Encounter. FIG. 11 is a hierarchy diagram showing the correlation type hierarchy.
“E12345” is an EMPI 1110 assigned by an Enterprise-Patient-Identifier System E1.
MRN123 is a MRN 1120 assigned by hospital/facility ADT system “H1.”
“Acct1” & “Acct 2” are account numbers 1130 and 1140 assigned by hospital/facility ADT system “H1.”
“V1,” “V2” & “V3” are visit numbers 1131, 1132, and 1141 assigned by hospital/facility ADT system “H1.” If visit numbers are not available, account numbers may be used.
“NPI123” is a Physician identifier 1160 assigned by an external authority “AA.”

The facility's operation in a number of scenarios is discussed below.

Scenario 1: Move encounter to different patient on explicit instruction triggered by new HL7 message (explicit handling)

| SEQUENCE | |
|---|---|
| NUMBER | INSTRUCTION |
| 3 | Encounter X moves from patient C to patient D |
| 1 | Encounter X moves from patient A to patient B |
| 2 | Encounter X moves from patient B to patient C |

1—Sequence Number 3 is processed first→Encounter X contains a reference to D and sequence number is 3. If patient D does not exist the message is either placed back in the processing queue or a “placeholder” identifier for patient D is created.

2—Sequence number 1 is processed next. Because it is a “re-parent/move” instruction and sequence number 3 has already been processed this is a no-operation as it pertains to correlation software process.

3—Sequence number 2 is processed next. Because it is a “re-parent/move” instruction and sequence number 3 has already been processed this is a no-operation as it pertains to correlation software process.

Scenario 2: Move encounter to different patient due to data inconsistency (implicit handling)

It is the responsibility of the correlation software process to guard against inconsistent data. For purpose of explanation assume Account is mapped to EncounterSet and “Medical Record Number” (MRN) is mapped to Patient:
Incoming HL7 Message 1: Account123, MRN456 (EncounterSet A, Patient B)
Incoming HL7 Message 2: Account123, MRN789 (EncounterSet A, Patient C)

An “Identifier Consistency Conflict” occurs if the 2 implied parents in the correlation type hierarchy each have a different source identifier. Sample HL7 message 2 detects a conflict because Account123 was previously assigned a different correlation parent. Conflicts like these are logged and may be resolved automatically based on policies configured by the tenant. The following scenarios provide details of how this works.

| SEQUENCE | |
|---|---|
| NUMBER | INSTRUCTION |
| 3 | Encounter X moves to patient C |
| 1 | Encounter X moves to patient A |
| 2 | Encounter X moves to patient B |

Scenario 2(a): The tenant has configured a policy to re-parent the identifier when a data inconsistency occurs (keep latest):

Step 1—Sequence Number 3 is processed first->Encounter X contains a reference to C and sequence number is 3. If patient C does not exist the message is either placed back in the processing queue or a “placeholder” identifier for patient C is created.

Step 2—Sequence number 1 is processed next. Because it is a “re-parent” instruction and sequence number 3 has already been processed this is a no-operation as it pertains to correlation software process.

Step 3—Sequence number 2 is processed next. Because the software process was configured to “re-parent” and sequence number 3 has already been processed this is a no-operation as it pertains to correlation software process.

Scenario 2(b): The tenant has configured a policy to Ignore the data inconsistency (keep first):

1—Sequence Number 3 is processed first->Encounter X contains a reference to patient C and sequence number is 3.

2—Sequence number 1 is processed next. Because it's an “ignore” instruction and sequence number 1 is smaller than 3->Encounter X replaces the reference and now references patient A.

3—Sequence number 2 is processed next. Because it is an “ignore” instruction and sequence number 3 has already been processed this is a no-operation as it pertains to correlation software process.

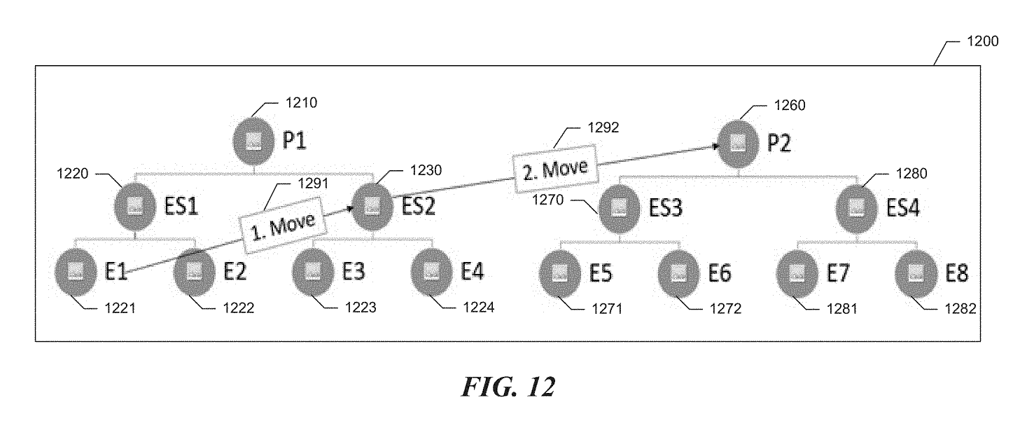

FIG. 12 is a hierarchy diagram showing an example of moving references within a correlation hierarchy in accordance with Scenario 2(b).

When sequence is in correct order:

| SEQUENCE | |
|---|---|
| NUMBER | INSTRUCTION |
| 1 | encounter set E1 1221 moves 1291 to |
| | encounter set ES2 1230 |
| 2 | encounter set ES2 1230 moves 1292 to |
| | patient P2 1260 |

Result after first execution
Re-parent/Move: E1 contains primary reference to ES2
Ignore: E1 contains primary reference to ES2

Result after second execution
Re-parent/Move: ES2 contains primary reference to P2
Ignore: ES2 contains primary reference to P2

When sequence is out of order:

| SEQUENCE | |
|---|---|
| NUMBER | INSTRUCTION |
| 2 | ES2 moves to P2 |
| 1 | E1 moves to ES2 |

Result after first execution
Re-parent/Move: ES2 contains primary reference to P2
Ignore: ES2 contains primary reference to P2

Result after second execution
Re-parent/Move: E1 contains primary reference to ES2
Ignore: E1 contains primary reference to ES2

the facility also solves the problem of processing out-of-order snapshot or incrementally changing data based on the three states described above when so configured.

Out-of-sequence processing of data that needs to be removed is achieved by using a technique known as “soft delete”. This means the data is not permanently deleted but only flagged as “removed”. If a record with a higher sequence number has been “soft deleted” a transaction with a lower sequence number containing changes to the “soft deleted” record becomes a no-operation.

Processing incrementally changing data that is out of sequence requires data to be separately stored for each HL7 field in the message. Each field maintains the last sequence number to be processed.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

We claim:

1. A method for processing data update messages, comprising:
in a parallel-processing data acquisition service:
receiving ordered batches of update messages, each identifying a feed;
for each received batch:
assigning unassigned sequence numbers to the messages of the received batch in the order of the received batch;
making the messages of the received batch available to a data shredding service along with their sequence numbers; and
responding to the received batch with an acknowledgment indicating that another batch of update messages may not be sent for the feed identified by the received batch;
in a parallel-processing data parsing service, for each received message, in accordance with the sequence numbers assigned to the received messages:
transforming data contained by the message into tables and columns;
extracting collapse key data from the message;
storing the extracted collapse key data;
extracting correlation identifiers from the message;
updating stored correlation information in accordance with the extracted correlation identifiers; and
in a parallel-processing entity mapping service, for each received message, in accordance with the sequence numbers assigned to the received messages:
populating the data model with based upon information about the received message provided by the data parsing service.

2. A computer-readable medium having contents configured to cause a computing system to process data update messages by:
establishing a plurality of units of execution each for executing data update message processing code;
receiving data update messages from a plurality of sending devices;
assigning each received data update message to a unit of execution without regard for which sending device it was received from; and
in each unit of execution, executing the code to process the received data update messages to which it is assigned.

3. The computer-readable medium of claim 2 wherein each of the received data update messages is an HL7 message.

4. The computer-readable medium of claim 2 wherein each unit of execution is a thread.

5. The computer-readable medium of claim 2 wherein each of the received data update messages conveys healthcare data.

6. The computer-readable medium of claim 2 wherein each of the received data update messages was created at a particular time,
and wherein the collective result of the received data update messages varies based upon the order in which the received data update messages,
and wherein the received data update messages are processed in a manner that produces the same result as if the received data update messages where processed in the order created.

7. The computer-readable medium of claim 2 wherein each of the received data update messages was created at a particular time,
and wherein the collective result of the received data update messages varies based upon the order in which the received data update messages,
and wherein the processing of the received data update messages by executing the code in each thread processes the received data update messages in an order that is arbitrary with respect to their creation times,
and wherein the received data update messages are processed in a manner that produces the same result as if the received data update messages where processed in the order created.

8. The computer-readable medium of claim 2 wherein each received data update message is of one of a plurality of message types, at least one received data update message being of each of the plurality of types,
and wherein receive data update messages are assigned to a thread without regard for their message type.

9. The computer-readable medium of claim 2 wherein each of the plurality of sending devices is operating on behalf of one of a plurality of tenants, at least one data update message being received from a device being operating on behalf of each of the plurality of tenant,
and wherein receive data update messages are assigned to a thread without regard for which tenant the sending device from which the data update message was received was operating on behalf of.

10. The computer-readable medium of claim 9 wherein the code executed by the threads selects a data store to be updated by each data update message based on which tenant the sending device from which the data update message was received was operating on behalf of.

11. The computer-readable medium of claim 9 wherein the code executed by the threads processes data update messages in a manner responsive to tenant-specific processing rules.

12. The computer-readable medium of claim 11 wherein processing at least a portion of the data update messages comprises storing data contained in the data update message in a data store,
and wherein the tenant-specific processing rules identify, for each tenant, which data in each data update message to store in the data store.

13. The computer-readable medium of claim 11 wherein processing at least a portion of the data update messages comprises collapsing data contained in the data update message about a collapse key contained in the data update message,
and wherein the tenant-specific processing rules specify, for each tenant, how to identify the collapse key in the data update message.

14. The computer-readable medium of claim 11 wherein each received data update message is of one of a plurality of message types,
and wherein the tenant-specific processing rules specify, for each tenant, a priority among message types for resolving conflicts between data update messages of different message types.

15. The computer-readable medium of claim 11 wherein the tenant-specific processing rules specify, for each tenant, whether a series of inconsistent data update messages this to be resolved in favor of the earliest of the inconsistent data update messages or the latest of the inconsistent data update messages.

16. The computer-readable medium of claim 2 having contents configured to further process data update messages by:
assigning each received data update message a unique sequence number, the assigned sequence numbers reflecting, among the data update messages received from each of the plurality of sending devices, the order in which the data update messages were created,
wherein the sequence numbers assigned to the received data update messages are used in processing the received data update messages to produce the same result as if the same result as if the data update messages received from each of the sending devices were processed in the order created.

17. The computer-readable medium of claim 16 wherein sequence numbers are assigned by sequence number assignment code executing in each of a plurality of sequence number assignment threads,
the computer-readable medium having contents configured to further process data update messages by:
for each received data update message, selecting a sequence number assignment thread to assign a sequence number to the received data update message without regard for which sending device it was received from.

18. The computer-readable medium of claim 16 wherein data update messages are received in batches of one or more data update messages,
the computer-readable medium having contents configured to further process data update messages by:
for each batch of data update messages received from a sending device, returning an acknowledgment of the batch of data update messages to the sending device only when sequence numbers have been assigned to the data update messages of the batch.

19. The computer-readable medium of claim 16 wherein processing a received data update message with respect to a data field comprises:
where the sequence number assigned to the received data update message is greater than a last-processed sequence number stored for the data field:
apply the received data update message to the data field; and
change the last-processed sequence number stored for the data field to the sequence number assigned to the received data update message; and
where the sequence number assigned to the received data update message is not greater than a last-processed sequence number stored for the data field:
concluding processing of the received data update message without applying the received data update message to the data field.

20. The computer-readable medium of claim 16 wherein processing a received data update message with respect to a data field comprises:
where the sequence number assigned to the received data update message is less than a last-processed sequence number stored for the data field:
apply the received data update message to the data field; and
change the last-processed sequence number stored for the data field to the sequence number assigned to the received data update message; and
where the sequence number assigned to the received data update message is not less than a last-processed sequence number stored for the data field:
concluding processing of the received data update message without applying the received data update message to the data field.

21. The computer-readable medium of claim 16 wherein processing a received data update message specifying deletion of an entity from a data store in connection with which the received data update messages being processed comprises:
without deleting the entity from the data store, flagging the entity as deleted; and
storing the sequence number assigned to the received data update message in connection with the deletion flag for the entity.

22. The computer-readable medium of claim 21 wherein processing a received data update message with respect to an entity that is the target of the received data update message comprises:
determining that the entity that is the target of the received data update message is flagged as deleted;
where the sequence number assigned to the received data update message is less than the sequence number stored in connection with the deletion flag for the entity that is the target of the received data update message:
applying the received data update message to the entity that is the target of the received data update message; and
where the sequence number assigned to the received data update message is not less than the sequence number stored in connection with the deletion flag for the entity that is the target of the received data update message:
concluding processing of the received data update message without applying the received data update message to the entity that is the target of the received data update message.

23. The computer-readable medium of claim 2 wherein processing a received data update message with respect to an entity that is the target of the received data update message comprises:
determining that, in a data store in connection with which the received data update messages is being processed, the entity that is the target of the received data update message does not exist; and, in response to the determining, creating in the data store a placeholder for the target entity.

24. A method in a computing system for processing data update messages, the method comprising:
establishing a plurality of units of execution each for executing data update message processing code;
receiving data update messages from a plurality of sending devices;
assigning each received data update message to a unit of execution without regard for which sending device it was received from; and
in each unit of execution, executing the code to process the received data update messages to which it is assigned.

25. The method of claim 24 wherein each of the received data update messages is an HL7 message.

26. The method of claim 24 wherein each unit of execution is a thread.

27. The method of claim 24 wherein each of the received data update messages conveys healthcare data.

28. The method of claim 24 wherein each of the received data update messages was created at a particular time,
and wherein the collective result of the received data update messages varies based upon the order in which the received data update messages,
and wherein the received data update messages are processed in a manner that produces the same result as if the received data update messages where processed in the order created.

29. The method of claim 24 wherein each of the received data update messages was created at a particular time,
and wherein the collective result of the received data update messages varies based upon the order in which the received data update messages,
and wherein the processing of the received data update messages by executing the code in each thread processes the received data update messages in an order that is arbitrary with respect to their creation times,
and wherein the received data update messages are processed in a manner that produces the same result as if the received data update messages where processed in the order created.

30. The method of claim 24 wherein each received data update message is of one of a plurality of message types, at least one received data update message being of each of the plurality of types,
and wherein receive data update messages are assigned to a thread without regard for their message type.

31. The method of claim 24 wherein each of the plurality of sending devices is operating on behalf of one of a plurality of tenants, at least one data update message being received from a device being operating on behalf of each of the plurality of tenant, and wherein receive data update messages are assigned to a thread without regard for which tenant the sending device from which the data update message was received was operating on behalf of.

32. The method of claim 31 wherein the code executed by the threads selects a data store to be updated by each data update message based on which tenant the sending device from which the data update message was received was operating on behalf of.

33. The method of claim 31 wherein the code executed by the threads processes data update messages in a manner responsive to tenant-specific processing rules.

34. The method of claim 33 wherein processing at least a portion of the data update messages comprises storing data contained in the data update message in a data store,
and wherein the tenant-specific processing rules identify, for each tenant, which data in each data update message to store in the data store.

35. The method of claim 33 wherein processing at least a portion of the data update messages comprises collapsing data contained in the data update message about a collapse key contained in the data update message,
and wherein the tenant-specific processing rules specify, for each tenant, how to identify the collapse key in the data update message.

36. The method of claim 33 wherein each received data update message is of one of a plurality of message types,
and wherein the tenant-specific processing rules specify, for each tenant, a priority among message types for resolving conflicts between data update messages of different message types.

37. The method of claim 33 wherein the tenant-specific processing rules specify, for each tenant, whether a series of inconsistent data update messages this to be resolved in favor of the earliest of the inconsistent data update messages or the latest of the inconsistent data update messages.

38. The method of claim 24, further comprising:
assigning each received data update message a unique sequence number, the assigned sequence numbers reflecting, among the data update messages received from each of the plurality of sending devices, the order in which the data update messages were created,
wherein the sequence numbers assigned to the received data update messages are used in processing the received data update messages to produce the same result as if the same result as if the data update messages received from each of the sending devices were processed in the order created.

39. The method of claim 38 wherein sequence numbers are assigned by sequence number assignment code executing in each of a plurality of sequence number assignment threads,
the method further comprising:
for each received data update message, selecting a sequence number assignment thread to assign a sequence number to the received data update message without regard for which sending device it was received from.

40. The method of claim 38 wherein data update messages are received in batches of one or more data update messages,
the method further comprising:
for each batch of data update messages received from a sending device, returning an acknowledgment of the batch of data update messages to the sending device only when sequence numbers have been assigned to the data update messages of the batch.

41. The method of claim 38 wherein processing a received data update message with respect to a data field comprises:
where the sequence number assigned to the received data update message is greater than a last-processed sequence number stored for the data field:
apply the received data update message to the data field; and
change the last-processed sequence number stored for the data field to the sequence number assigned to the received data update message; and
where the sequence number assigned to the received data update message is not greater than a last-processed sequence number stored for the data field:
concluding processing of the received data update message without applying the received data update message to the data field.

42. The method of claim 38 wherein processing a received data update message with respect to a data field comprises:
where the sequence number assigned to the received data update message is less than a last-processed sequence number stored for the data field:
apply the received data update message to the data field; and
change the last-processed sequence number stored for the data field to the sequence number assigned to the received data update message; and
where the sequence number assigned to the received data update message is not less than a last-processed sequence number stored for the data field:
concluding processing of the received data update message without applying the received data update message to the data field.

43. The method of claim 38 wherein processing a received data update message specifying deletion of an entity from a data store in connection with which the received data update messages being processed comprises:
without deleting the entity from the data store, flagging the entity as deleted; and
storing the sequence number assigned to the received data update message in connection with the deletion flag for the entity.

44. The method of claim 43 wherein processing a received data update message with respect to an entity that is the target of the received data update message comprises:
determining that the entity that is the target of the received data update message is flagged as deleted;
where the sequence number assigned to the received data update message is less than the sequence number stored in connection with the deletion flag for the entity that is the target of the received data update message:
applying the received data update message to the entity that is the target of the received data update message; and
where the sequence number assigned to the received data update message is not less than the sequence number stored in connection with the deletion flag for the entity that is the target of the received data update message:
concluding processing of the received data update message without applying the received data update message to the entity that is the target of the received data update message.

45. The method of claim 24 wherein processing a received data update message with respect to an entity that is the target of the received data update message comprises:
determining that, in a data store in connection with which the received data update messages is being processed, the entity that is the target of the received data update message does not exist; an in response to the determining, creating in the data store a placeholder for the target entity.
